(19) United States
(12) Patent Application Publication
(10) Pub. No.: US 2026/0062525 A1
(43) Pub. Date: Mar. 5, 2026

(54) PRODUCT AND METHOD FOR PRODUCING THE SAME

(71) Applicant: UPM-Kymmene Corporation, Helsinki (FI)

(72) Inventors: Janak SAPKOTA, Helsinki (FI); Teemu POHJALAINEN, Helsinki (FI); Matti RISTOLAINEN, Helsinki (FI); Pasi VIRTANEN, Helsinki (FI); Harri KOSONEN, Helsinki (FI); Sakari MODIG, Helsinki (FI)

(21) Appl. No.: 19/106,806

(22) PCT Filed: Sep. 4, 2023
(86) PCT No.: PCT/FI2023/050502

§ 371 Date: Feb. 26, 2025

(30) Foreign Application Priority Data
Sep. 13, 2022 (FI) 20225794

(51) Int. Cl. C08J 5/18; D21H 11/20; D21H 19/34

(52) U.S. Cl. CPC C08J 5/18; D21H 11/20; D21H 19/34

(57) ABSTRACT

A product is disclosed. The product may comprise a layer formed at least partially of a mixture comprising a reinforcing component and at least 10% (w/w) of cellulose fibers having surface-closing proper-ties.

### TECHNICAL FIELD

The present disclosure relates to a product and a method for producing the product.

### BACKGROUND

The demand for packaging materials is growing significantly. Packaging solutions that are renewable, recyclable as well as biodegradable are in need.

Cellulose, for example in the form of cellulose fibers or pulp, is a renewable and biodegradable material well suited for packaging solutions. However, often plastic materials or other less environmentally friendly materials, such as fluorinated compounds, may be required e.g. as coatings to impart barrier properties to packaging materials formed mainly from cellulose. Such packaging materials are not fully biodegradable, and their recycling may be complicated.

### SUMMARY

A product is disclosed. The product may comprise a layer formed at least partially of a mixture comprising a reinforcing component and at least 10% (w/w) of cellulose fibers having surface-closing properties.

### BRIEF DESCRIPTION OF THE DRAWINGS

The accompanying drawings, which are included to provide a further understanding of the embodiments and constitute a part of this specification, illustrate various embodiments. In the drawings:

FIG. 1A illustrates an embodiment of the product in cross-sectional view;

FIG. 1B describes another embodiment of the product;

FIG. 1C describes another embodiment of the product;

FIG. 2A illustrates an embodiment of the product in cross-sectional view;

FIG. 2B describes another embodiment of the product;

FIG. 2C describes another embodiment of the product;

FIG. 2D describes yet another embodiment of the product;

FIG. 2E describes yet another embodiment of the product;

FIG. 3A shows the oxygen transmission rate of a cellulosic film;

FIG. 3B shows the grease permeability of the cellulosic film;

FIG. 4 illustrates packaging material produced by compression molding a fiber body with a cellulosic filmic layer;

FIG. 5 illustrates packaging material produced by calendering a fiber body with cellulosic filmic layer;

FIG. 6A illustrates apparent bulk density values for specific fiber mixtures;

FIG. 6B shows tensile index values for specific fiber mixtures;

FIG. 6C shows strain at break values for specific fiber mixtures; and

FIG. 7 shows air permeance measurements of multilayer structures.

### DETAILED DESCRIPTION

A product is disclosed.

The product may comprise a layer formed at least partially of a mixture comprising a reinforcing component and at least 10% (w/w) of cellulose fibers having surface-closing properties.

The cellulose fibers having surface-closing properties are a moldable material, and when the mixture comprising the cellulose fibers having surface-closing properties is densified e.g. by compressing, a layer with low porosity may be obtained. For example, with calendering, a very dense structure may be obtained from the mixture. Such a layer may have barrier properties. For example, it may have gas (oxygen) barrier and/or grease barrier layer, such as oil barrier layer, properties.

The reinforcing component, such as cellulose fibers, may provide mechanical strength to the product.

A layer of a reinforcing component, such as a layer of cellulose fibers, e.g. chemical pulp, has a good strength but a porous structure; a layer of cellulose fibers having surface-closing properties, such as hydrolysed cellulose fibers, may provide a dense, more smooth structure but little strength. The mixture comprising the reinforcing component and at least 10% (w/w) of the cellulose fibers having surface-closing properties may provide a balance between strength and density as well as provide a smooth surface finish.

The relative proportions of the reinforcing component and of the cellulose fibers having surface-closing properties may be selected such that the strength and, on the other hand, the density of the layer may be optimized as desired. The composition of the mixture may also be selected such that desired barrier properties are obtained.

Such a product does not necessarily need e.g. a plastic coating or other layers or coatings that are not cellulose-based. For example, barrier properties have traditionally been achieved using fluorochemicals, which are harmful e.g. to the environment and the use of which may be phased out in the future. Obviating or reducing the need to use additional surface chemicals, layers or coatings to achieve barrier properties may be highly useful e.g. for environmental reasons. The product according to one or more embodiments described in this specification may be biodegradable and relatively easily recyclable with existing processes. For example, up to 50% of the cellulose fibers in the product may be recoverable in a recycling process. The product may be compostable. The product may be burned and may burn relatively cleanly.

The cellulose fibers having surface-closing properties may have a CED viscosity in the range of 50 to 500 ml/g, or in the range of 50 to 400 ml/g, or in the range of 120 to 300 ml/g, or in the range of 140 to 200 ml/g.

The cellulose fibers having surface-closing properties may be modified cellulose fibers. The modified cellulose fibers may comprise or be e.g. hydrolysed cellulose fibers; nanocellulose; microfibril cellulose; or any mixture or combination thereof.

The cellulose fibers having surface-closing properties may comprise or be hydrolysed cellulose fibers. Hydrolysed cellulose fibers are readily available and have properties well suited for being included in the mixture.

In the context of the present disclosure, the term “hydrolysed cellulose fibers” may be understood as referring to cellulose fibers that have been subjected to a treatment which has hydrolysed the cellulose chains of the cellulose fibers at least partially, for example as compared to comparable, non-hydrolysed cellulose fibers. The hydrolysis may be obtainable by alkaline hydrolysis, autohydrolysis, or other type of hydrolysis. Thus the average length of the cellulose chains of the hydrolysed cellulose fibers may be smaller than the average length of the cellulose chains of comparable cellulose fibers that are unhydrolysed. Certain properties, such as CED viscosity, of the cellulose fibers may be affected by the hydrolysis. The hydrolysed cellulose fibers may be obtainable or obtained e.g. by a 2-3-h enzymatic hydrolysis of the cellulose fibers utilizing cellulolytic enzymes, and/or by acid or alkaline hydrolysis. The hydrolysed cellulose fibers may be or comprise e.g. hydrolysed pulp. In this context, the pulp of the hydrolysed pulp may be any pulp described in this specification.

The cellulose fibers having surface-closing properties, such as modified cellulose fibers, may be e.g. obtainable or obtained by hydrolysis or by electron beam technology, optionally followed by further hydrolysis, such as alkaline hydrolysis.

The hydrolysed cellulose fibers may have a CED viscosity in the range of 50 to 500 ml/g. In some embodiments, the hydrolysed cellulose fibers may have a CED viscosity in the range of 50 to 400 ml/g, or in the range of 120 to 300 ml/g, or in the range of 140-200 ml/g.

The term “CED viscosity” may be understood as referring to limiting viscosity number in cupri-ethylenediamine (CED) solution. The CED viscosity may be measured e.g. according to the standard ISO 5351:2010.

The hydrolysed cellulose fibers may have a degree of polymerization (DP) in the range of about 100 to 700, or in the range of about 120 to 300. The degree of polymerization may be measured e.g. using the standard ISO 5351:2010 (en). The degree of polymerization (DP) may be estimated from the CED viscosity value obtained according to the standard according to:
DP=0.75 [μ]^{1/0.905} where [μ] is the CED viscosity value.

The cellulose fibers having surface-closing properties may, in some embodiments, be obtainable by a pretreatment or modification, for example a with a surface modification, saponification of cellulose esters, or phosphorylation. The cellulose fibers having surface-closing properties may have traces of processes causing e.g. changes in the surface chemistry.

The proportion of at Least 10% (w/w) of cellulose fibers having surface-closing properties may be understood as the dry weight of the cellulose fibers having surface-closing properties based on the total dry weight of the mixture and/or the total dry weight of the layer formed at least partially of the mixture.

The mixture may comprise e.g. at least 20% (w/w), or at least 30% (w/w), or at least 40% (w/w), or at least 50% (w/w), at least 60% (w/w), or at least 70% (w/w), or at least 80% (w/w), or 100% (w/w) of the cellulose fibers having surface-closing properties.

The properties, such as degree of polymerization and/or CED viscosity of the cellulose fibers having surface-closing properties and of the reinforcing component, such as cellulose fibers, may differ from each other. The proportions of the cellulose fibers having surface-closing properties and the reinforcing component, and optionally of other components, may be selected such that the properties of the layer formed at least partially of the mixture are as desired. For example, an increase in the proportion of the cellulose fibers having surface-closing properties may increase the density of the layer formed at least partially of the mixture, which in turn may decrease the permissibility to e.g. grease and/or oxygen. The proportion of the cellulose fibers having surface-closing properties may thus be selected so as to achieve a desired density, desired barrier properties and/or desired smoothness. The reinforcing component may be provided as a desired proportion e.g. to provide a desired strength and/or other properties to the layer formed at least partially of the mixture.

The CED viscosity of the reinforcing component, such as cellulose fibers, may be greater than 500 ml/g, e.g. in the range of about 500 to 3000 ml/g. In some embodiments, the CED viscosity of the reinforcing component, such as cellulose fibers, may be e.g. in the range of 800 to 1200 ml/g, or in the range of 900 to 1100 ml/g.

In embodiments in which the reinforcing component comprises or is cellulose fibers, the cellulose fibers of the reinforcing component may be other cellulose fibers, i.e. cellulose fibers other from the cellulose fibers having surface-closing properties.

The reinforcing component, such as cellulose fibers, may comprise or be e.g. unmodified and/or non-hydrolysed cellulose fibers.

The fibers of the cellulose fibers (including cellulose fibers of the reinforcing component and/or of the cellulose fibers having surface-closing properties, such as hydrolysed or non-hydrolysed cellulose fibers cellulose fibers) may be natural fibers, such as ligno-cellulosic fibers, cellulose fibers, cellulose fiber derivatives, wood derivatives or any combinations or mixtures thereof. The fibers in the cellulose fibers may be natural fibers, such as modified natural origin fibers, and/or cellulose-based fibers. The fibers in the cellulose fibers may be virgin, recycled or secondary natural fibers, or any mixture or combination thereof. The cellulose fibers may be e.g. staple fibers. The cellulose fibers may be fibers derived from e.g. cotton or cotton linter. The cellulose fibers may comprise or be e.g. pulp. The pulp may comprise or be e.g. wood pulp (such as hardwood and/or softwood pulp), non-wood pulp, and/or agropulp. The pulp may be chemical pulp, such as kraft pulp, soda, sulphate, or organosolv pulp. The pulp may be mechanical & thermal pulp (TMP), mechanical pulp (groundwood (GW), pressure ground wood pulp (PGW), refiner mechanical pulp (RMP) ), and/or chemi-thermomechanical pulp (CTMP). The pulp may, additionally or alternatively, be never dried pulp, such as never dried kraft pulp. The cellulose fibers or the pulp may comprise or be recycled fibers. The fibers in the cellulose fibers may comprise or be at least one of wood pulp, non-wood pulp, staple fibers, recycled fibers, or any mixture or combination thereof. In some embodiments, the fibers in the cellulose fibers may not comprise man-made fibers and/or oil-based fibers. Staple fibers with a desired length may be combined with other types of reinforcing components, such as other types of cellulose fibers.

The reinforcing component, such as cellulose fibers, may comprise or be natural fibers having a CED viscosity in the range of 500-3000 ml/g and/or man-made cellulosic fibers. The man-made cellulosic fibers may, at least in some embodiments, have a lower CED viscosity.

In the context of this specification, the term “unmodified cellulose fibers” may refer to cellulose fibers that are not purposefully chemically modified to a significant extent. The unmodified cellulose fibers may e.g. be unhydrolyzed. However, the unmodified cellulose fibers may be e.g. chemical pulp, such as Kraft pulp, and may be e.g. bleached during the production process of the chemical pulp. Although e.g. the Kraft pulping process may lead to minor hydrolysis of the cellulose fibers, chemical pulp may still be considered to be or contain unmodified cellulose fibers.

The reinforcing component, such as cellulose fibers, may be or comprise chemical pulp, such as Kraft pulp, sulphate pulp, and/or organosolv pulp; and/or staple fibers.

The mixture may comprise about 10 to 90% (w/w) of the cellulose fibers having surface-closing properties, and about 10 to 90% (w/w) of the reinforcing cellulose fibers.

The mixture may comprise about 20 to 50% (w/w) of the cellulose fibers having surface-closing properties, and about 50 to 80% (w/w) of the reinforcing component, such as cellulose fibers.

The mixture may comprise about 20 to 40% (w/w) the cellulose fibers having surface-closing properties, and about 60 to 80% (w/w) of the reinforcing component, such as cellulose fibers.

The weight ratio of the cellulose fibers having surface-closing properties to the reinforcing component, such as cellulose fibers, may be in the range of about 10:90to about 50:50, or in the range of about 20:80 to about 40:60.

The product may be a moldable product or a molded product.

The moldable product may be e.g. a sheet or a flat structure. Such a moldable product may be molded to a final form having a desired shape. Various methods for molding the product may be available.

The molded product may be e.g. a container or a receptacle, such as a cup or a plate. However, the shape of the molded product is not particularly limited.

The product may be flexible, or a flexible product. The product may alternatively be rigid, or a rigid product.

The product may be e.g. a packaging material, a packaging paper, a wrapping paper, a protective paper, a packaging board, a packaging 3D material, a decorative paper, an envelope, a container, or a release liner.

The product may be mainly formed of cellulose-based materials.

In some embodiments, the product may be formed essentially or entirely of cellulose-based materials.

However, the presence of minor amounts of non-cellulose-based materials is not necessarily excluded in such a product. For example, the product that is mainly or essentially formed of cellulose-based materials may contain e.g. an adhesive, such as glue, an additive, a color or an ink, that is not cellulose-based.

In the context of this specification, the term “mainly formed of cellulose-based materials” may refer to a product, at least 85% (w/w), or at least 95% (w/w), or at least 98% (w/w), or at least 99% (w/w), or 100% (w/w) of the material of which is cellulose-based.

The product may be biodegradable. The product may be biodegradable as determined by the standard OECD for testing of chemicals 301 F.

The term “biodegradable” may, at least in some embodiments, refer to readily biodegradable as determined by the standard OECD for testing of chemicals 301 F (Manometric respiratory test). The readily biodegradable product may be a product for which at least 60% biodegradability is reached within 28 days as determined by the standard OECD for testing of chemicals 301 F.

The product may be recyclable.

The product may comprise or consist of a single layer formed at least partially of the mixture comprising the reinforcing component, such as cellulose fibers, and at least 10% (w/w) of cellulose fibers having surface-closing properties. The product may comprise a single layer of the mixture. In other words, the product may be a monolayer product. However, in some embodiments, the product may comprise e.g. two or more layers formed at least partially of the mixture. In such embodiments, the product may thus be formed by adding two or more layers formed of the mixture, such that effectively a single layer is created. The product may consist of one or more layers formed of the mixture.

The product may, in other embodiments, comprise one or more layers, for example two or more layers. At least one of the layers of the product may be a layer formed at least partially of the mixture comprising the reinforcing component, such as cellulose fibers, and at least 10% (w/w) of cellulose fibers having surface-closing properties.

In the context of this specification, unless otherwise specified, the term “the layer” may be understood as referring to the layer formed at least partially of the mixture comprising the reinforcing component, such as cellulose fibers, and at least 10% (w/w) of cellulose fibers having surface-closing properties.

The product may comprise an additional layer, or one or more additional layers. In other words, in some embodiments, the product may be a multilayer product. For example, the product may comprise an additional base layer. Such a base layer may have a composition different from the composition of the layer formed at least partially of the mixture. Such a base layer may be formed at least partially of e.g. a reinforcing component, such as cellulose fibers. The reinforcing component, such as cellulose fibers, of the base layer may be e.g. any reinforcing component described in this specification. The product may comprise one or more base layers, for example one or two base layers.

The product may further comprise additional layers. For example, the product may comprise a middle layer (or at least one middle layer) between the base layer and the layer formed at least partially of the mixture. Such a middle layer may also be cellulose fiber-based. However, its composition may be different from the base layer and/or the layer formed at least partially of the mixture.

The product may comprise a base layer and two layers formed at least partially of the mixture, the layers formed at least partially of the mixture arranged at opposite sides of the base layer.

The product may comprise a layer formed at least partially of the mixture and two base layers, the base layers arranged at opposite sides of the layer formed at least partially of the mixture.

The layer(s) formed at least partially of the mixture may be densified and/or compressed. In other words, the layer formed at least partially of the mixture may be a densified and/or compressed layer.

The base layer(s) may be densified and/or compressed. In other words, the base layer may be a densified and/or compressed layer.

Both the layer formed at least partially of the mixture and the base layer (or any or all such layers) may be densified and/or compressed.

The densification may be performed e.g. by wet or dry calendering. Wet calendering may improve the densifying even further.

However, compression or densification may not always be necessary to achieve desired barrier properties. For example, the layer formed at least partially of the mixture may be formed by spraying the material of the layer onto a base layer (or, in some embodiments, onto another additional layer). By way of another example, the layer formed at least partially of the mixture and the base layer (and any additional layers, if present) may be formed e.g. in a two-layer or multilayer headbox of a paper machine or board machine.

The densification and/or compression may provide e.g. a certain oxygen transmission rate to the layer and/or the product. The densification and/or compression may provide e.g. a certain smoothness to the layer and/or the product.

The layer formed at least partially of the mixture may have a weight in the range of 20 to 1000 gsm (grams per square meter). However, the weight (grammage) of the layer may depend e.g. on whether the product comprises any further layers.

The layer formed at least partially of the mixture may, at least in some embodiments, have a thickness of 300 μm or less, or in the range of 1-200 μm, or in the range of 10-100 μm, or in the range of 10-40 μm. However, the thickness of the layer may depend e.g. on whether the product comprises any further layers. A product, such as a molded cup or tray, that is in the form of a monolayer may be quite thick. In products that comprise a further layer, for example a reinforcing base layer, the layer formed at least partially of the mixture may be relatively thin.

The base layer may formed of a densified cellulose fiber mixture.

The base layer may have a weight e.g. of at least 20 gsm, or in the range of 20-800 gsm, or in the range of 40-800 gsm (grams per square meter).

In some embodiments, the product does not comprise any plastic or metal. The product may, in some embodiments, not comprise inorganic materials, such as pigments.

The product may further comprise a surface chemical for providing barrier properties applied to the layer formed at least partially of the mixture. Such a surface chemical may comprise or be starch, a wax, a fatty acid, an alkyl ketene dimer, an alkyl succinic anhydride, a thermoplastic component, or any combination or mixture thereof. The surface chemical may or may not react with the cellulose of the cellulose fibers chemically; this may depend on its chemical properties. The surface chemical may attach to the cellulose covalently or non-covalently. The surface chemical may physically attach to the cellulose. It may e.g. impregnate the layer formed at least partially of the mixture and/or the base layer, and/or any other additional layer, and provide desired physical properties to the product.

The product may further comprise a coating covering the layer formed at least partially of the mixture and/or the base layer, or any other layer.

The coating may be the outermost layer of the product.

The coating may be or be applied as e.g. a hot melt coating, a dip coating, or a carton coating. Such a coating, e.g. a hot melt coating, may improve the heat-sealing properties of the product.

The product may further comprise a cellulosic filmic layer. In other words, the product may further comprise a coating, which is a cellulosic filmic layer. The cellulosic filmic layer may be formed by coagulating alkaline cellulose dope. The cellulosic filmic layer may cover the layer formed at least partially of the mixture and/or the base layer, or any other layer if present. The cellulosic filmic layer may cover the layer formed at least partially of the mixture and/or the base layer, or any other layer if present, such that the cellulosic filmic layer may be the outermost layer of the product. The cellulosic filmic layer may improve the oxygen and/or grease barrier properties of the product. Such an embodiment may not necessarily be moldable, however. The cellulosic filmic layer may be added when the product has been molded. When the coating is a cellulosic filmic layer, it may also be biodegradable. Thus the entire product may be cellulose-based and optionally biodegradable, as opposed e.g. to a product comprising a plastic coating.

In the context of this specification, the term “alkaline cellulose dope” may be understood as a solution comprising cellulose solubilized in an alkaline solution, often in a cold alkaline solution. For example, the alkaline cellulose dope may be a cellulose spinning solution (i.e. an alkaline cellulose spinning solution) or a cellulose solution (i.e. alkaline cellulose solution) for extrusion, spinning, electrospinning, molding, casting, film forming, film extrusion, cellulose pearl production, coating, spraying and/or 3D printing. In other words, it may refer to cellulosic material in alkaline solution suitable for use e.g. in spinning filaments, staple fibers, film making, cellulose pearl production, and various other purposes. The cellulose alkaline cellulose dope may be coagulated in suitable conditions into solid cellulose, for example into type II cellulose.

Providing the cold alkaline solution may typically comprise mixing and/or dissolving an alkaline agent, such as NaOH, and optionally a dissolution or stabilizing agent, for example a zinc compound, such as Zno, with water. They may be mixed at conditions suitable for dissolving the components in water, for example at an elevated temperature and such that the alkaline agent, such as NaOH, is added at a concentration of at least 40% (w/w) . The elevated temperature may be e.g. a temperature of at least 60° C. The resulting alkaline solution may then be diluted. The alkaline agent in the (cold) alkaline solution may comprise or be e.g. NaOH, LiOH, KOH, and/or any mixture or combination thereof.

The cellulosic filmic layer may be applied e.g. by calendering. This may be done e.g. such that a cellulosic film is prepared, for example by extruding and coagulating an alkaline cellulose dope, and preparing the product separately. The product and the cellulosic film may be combined and calendered, such that the cellulosic film is attached to the product and forms the cellulosic filmic layer.

The cellulosic filmic layer may, alternatively, be formed by surface treatment. The product may be surface treated e.g. with a hydroxide, such as NaOH, such that cellulose fibers at the surface of the product are at least partially solubilized and subsequently coagulated, thereby forming a cellulosic filmic layer. The cellulosic filmic layer formed by the surface treatment may be similar to a cellulosic filmic layer prepared e.g. by coagulating an alkaline cellulose dope.

The product may further comprise an adhesive layer between the layer formed at least partially of the mixture and an additional layer, such as a base layer. The product, such as a multilayer product, may comprise an adhesive layer (or a further adhesive layer) between one or more other layers. The adhesive layer may attach the layer formed at least partially of the mixture and the base layer, and/or any other layer(s) (depending on the embodiment and the presence and arrangement of the layers), to each other. The adhesive may be e.g. a bio-based and/or biodegradable adhesive, such as a bio-based and/or biodegradable glue.

The product may further comprise an ink and/or lacquer layer. The ink and/or lacquer layer may be formed e.g. by printing ink on or by lacquering a surface of the product.

The product, in particular when it does not comprise the cellulosic filmic layer, may have an oxygen transmission rate of 1000 cm³/(m²·day) or less, or of 100 cm³/(m²·day) or less, or of 20 cm³/(m²·day) or less. In other embodiments, the product, in particular when it comprises the cellulosic filmic layer, may have an oxygen transmission rate of 20 cm³/(m²·day) or less, or of 5 cm³/(m²·day) or less, or of 1 cm³/(m²·day) or less.

The oxygen transmission rate may be measured at 23° C. and 50% relative humidity. The oxygen transmission rate may be measured using a MOCON OX-TRAN@ instrument. The instrument design operations may be consistent with the ASTM D 3985 standard. The oxygen transmission rate may, in some embodiments, be measured according to one of the standards ASTM D3985, ASTM F1927, or ISO 15105-2, using a Mocon Ox-Tran 2/21 MH instrument. In an embodiment, the oxygen transmission rate is measured day at 23° C. and 0% relative humidity with 100% 02 using a MOCON OX-TRAN instrument in accordance with the ASTM D 3985 standard.

The product, in particular when it does not comprise the cellulosic filmic layer, may have an oxygen transmission rate of 1000 cm³/(m²·day) or less, or of 100 cm³/(m²·day) or less, or of 20 cm³/(m²·day) or less, measured day at 23° C. and 0% relative humidity with 100% O₂. In other embodiments, the product, in particular when it comprises the cellulosic filmic layer, may have an oxygen transmission rate of 20 cm³/(m²·day) or less, or of 5 cm³/(m²·day) or less, or of 1 cm³/(m²·day) or less, measured day at 23° C. and 0 % relative humidity with 100% O₂.

The composition of the product, such as the presence or absence of a cellulosic filmic layer or a surface chemical, or densification and/or compression, may have significant effects on the water vapor permeability and oil permeability (as measured e.g. by heptane vapour transmission rate). Thus the values of such parameters may vary significantly for products according to various embodiments described herein.

The water vapor permeability of the product, in particular a product that comprises the cellulosic filmic layer, may be e.g. 300 g/(m²·day) or less, or 100 g/(m²·day) or less, or 30 g/(m²·day) or less. The water vapor permeability may be determined at 23° C. and 50% relative humidity.

The water vapor permeability of the product, in particular a product that comprises a cellulosic filmic layer and a surface chemical (such as any surface chemical described in this specification) and/or that is densified e.g. by calendering, may be e.g. 100 g/(m²·day) or less, or 50 g/(m²·day) or less, or 20 g/(m²·day) or less. The water vapor permeability may be determined at 23° C. and 50% relative humidity.

The product, in particular a product that comprises the cellulosic filmic layer, may have a heptane vapor transmission rate of e.g. 100 g/(m²·day) or less, or 50 g/(m²·day) or less, or 5 g/(m²·day) or less. The heptane vapor transmission rate may be determined at 23° C. and 50% relative humidity.

The product may be semi-transparent and/or translucent. This may depend e.g. on the composition of the layer formed at least partially of the mixture and of any other additional layers. The layer formed at least partially of the mixture and e.g. a base layer may be densified to such an extent that it is translucent and/or semi-transparent.

The light transmittance of the product may be in the range of 0 to 70%, or in the range of 1 to 70% or of 20 to 70%. The light transmittance may be understood as referring to visible light transmittance. The light transmittance may be measured e.g. with an optical profiler.

A method for producing the product according to one or more embodiments described in this specification is disclosed. The method may comprise forming layer from the mixture comprising the reinforcing component, such as cellulose fibers, and the cellulose fibers having surface-closing properties.

The method may comprise providing the mixture comprising the reinforcing component, such as cellulose fibers, and the cellulose fibers having surface-closing properties; and forming the layer. The product may be obtained thereby. For example, a monolayer product may thus be obtained.

The method may comprise providing the mixture comprising the reinforcing component, such as cellulose fibers, and the cellulose fibers having surface-closing properties; providing the material of the base layer; forming the layer from the mixture comprising the reinforcing component, such as cellulose fibers, and the cellulose fibers having surface-closing properties; forming the base layer; and forming the product there-from.

The materials and compositions of the materials of the layer and e.g. of the base layer, if present, may be according to one or more embodiments described in this specification.

The mixture comprising the reinforcing cellulose fibers and the cellulose fibers having surface-closing properties may be formed into a web, and the web may be calendered, such that the layer formed at least partially of the mixture is formed. The densifying may be performed e.g. by wet or dry calendering. Wet calendering may improve the densifying even further. The web may be calendered e.g. using a nip pressure of 3 to 350 kN/m.

The method may further comprise molding the product. The product may be molded from a dry web or from suspension.

The cellulosic filmic layer may be applied by calendering. This may be done e.g. such that a cellulosic film is prepared, for example by extruding and coagulating an alkaline cellulose dope, and preparing the product separately. The product and the cellulosic film may be combined and calendered, such that the cellulosic film is attached to the product and forms the cellulosic filmic layer.

The method may further comprise forming a cellulosic filmic layer to the product by surface treatment. The product may be surface treated e.g. with a hydroxide, such as NaOH, such that cellulose fibers at the surface of the product are at least partially solubilized and subsequently coagulated, thereby forming a cellulosic filmic layer. The cellulosic filmic layer formed by the surface treatment may be similar to a cellulosic filmic layer prepared e.g. by coagulating an alkaline cellulose dope.

### EXAMPLES

Reference will now be made in detail to various embodiments, exampled of which are illustrated in the accompanying drawings.

The description below discloses some embodiments in such a detail that a person skilled in the art is able to utilize the embodiments based on the disclosure. Not all steps or features of the embodiments are discussed in detail, as many of the steps or features will be obvious for the person skilled in the art based on this specification.

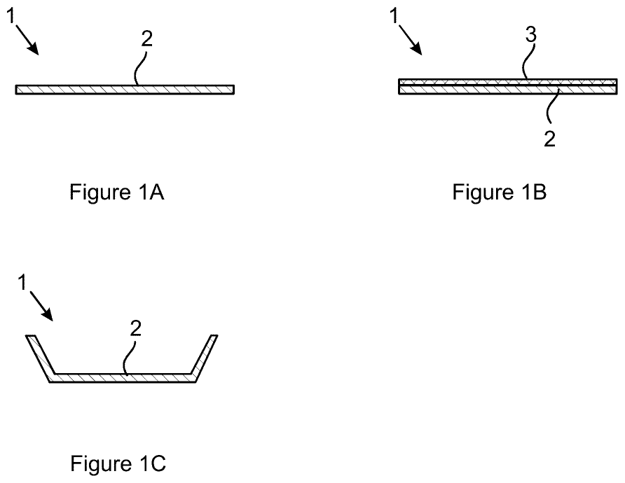

FIG. 1A describes an embodiment of the product 1 in cross-sectional view. The product 1 is a monolayer product comprising a layer 2 formed of a mixture comprising cellulose fibers as a reinforcing component and at least 10% (w/w) of cellulose fibers having surface-closing properties. The composition of the mixture forming the layer 2 may be any composition for the mixture described in this specification. The product 1 in this exemplary embodiment is flat or sheet-like, and may be moldable into a desired shape.

FIG. 1B describes another embodiment of the product 1. The product 1 is similar to the one depicted in FIG. 1A, except that the product 1 further comprises a coating 3. The coating may be e.g. a plastic coating. In some embodiments, the coating 3 may be e.g. a cellulosic filmic layer. The coating 3 is arranged on the layer 2 formed of the mixture. It covers the layer 2 at least partially, or as shown in FIG. 1B, entirely.

FIG. 1C describes another embodiment of the product 1 in cross-sectional view. The product 1 is similar to the one depicted in FIG. 1A, except that it is a molded product, for example a cup or a tray. As a skilled person will understand, various other shapes may be contemplated.

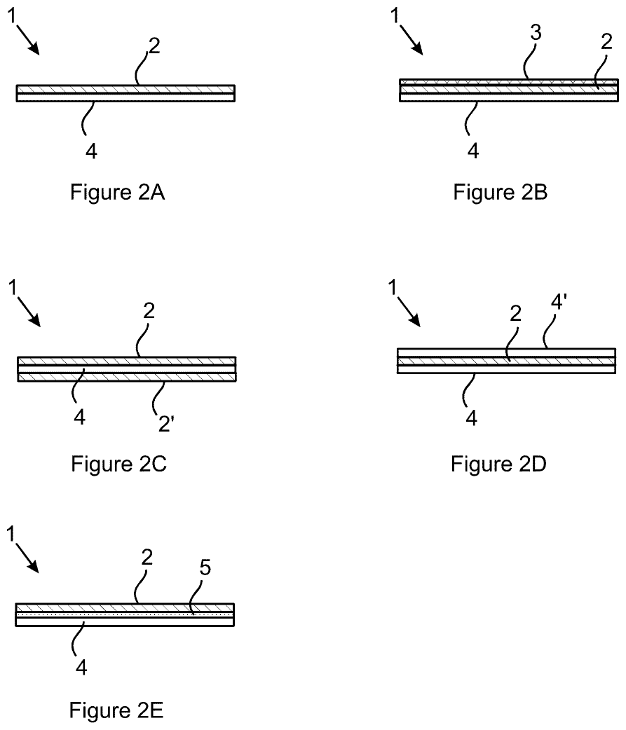

FIG. 2A describes an embodiment of the product 1 in cross-sectional view. In this exemplary embodiment, the product 1 is a multilayer product. The multilayer product 1 comprises a layer 2 formed of a mixture comprising cellulose fibers as reinforcing component and at least 10% (w/w) of cellulose fibers having surface-closing properties and a base layer 4 formed e.g. of a reinforcing component, such as cellulose fibers. The layer 2 covers the base layer 4 at least partially, or as shown in FIG. 2A, entirely.

FIG. 2B describes another embodiment of the multilayer product 1. The multilayer product 1 is similar to the one depicted in FIG. 2A, except that the multilayer product 1 further comprises a coating 3. The coating may be similar to the one described in FIG. 1B, e.g. a plastic coating. In some embodiments, the coating 3 may be e.g. a cellulosic filmic layer. The coating 3 is arranged on the layer 2 formed of the mixture. It covers the layer 2 at least partially, or as shown in FIG. 2B, entirely. However, as a skilled person will understand, the coating 3 could alternatively or additionally be arranged on the base layer 4. A skilled person will also understand that the coating 3 could also be included in any one of the embodiments depicted in FIGS. 2C to 2E.

FIG. 2C describes another embodiment of the multilayer product 1. The multilayer product 1 is similar to the one depicted in FIG. 2A, except that the multilayer product 1 comprises three layers: a base layer 4 and two layers 2 and 2′formed of the mixture. The layers 2 and 2′are arranged on opposite sides of the base layer 4.

FIG. 2D describes yet another embodiment of the multilayer product 1. The multilayer product 1 is similar to the one depicted in FIG. 2C, except that the multilayer product 1 comprises three layers: two base layers 4 and 4′and a layer 2 formed of the mixture. The base layers 4 and 4′are arranged on opposite sides of the layer 2.

FIG. 2E describes yet another embodiment of the multilayer product 1. The multilayer product 1 is similar to the one depicted in FIG. 2A, except that the multilayer product 1 further comprises an adhesive layer 5 between the base layer 4 and the layer 2 formed at least partially of the mixture. The adhesive layer 5, extending between the base layer 4 and the layer 2, may attach the base layer 4 and the layer 2 to each other. The adhesive in the adhesive layer 5 may be e.g. any adhesive described in this specification.

The exemplary embodiments shown in FIGS. 2A to 2E are flat or sheet-like, and may be moldable or molded into a desired shape.

### Example 1

The oxygen transmission rate (OTR) and grease permeability of a cellulosic film were measured. Cellulosic films were prepared by regenerating alkaline cellulose dope in citric acid, with or without plasticizer, and dried the produced films at 180° C. and 410 kPa for 3 min. Oxygen transmission rate and fat permeability of the films were measured.

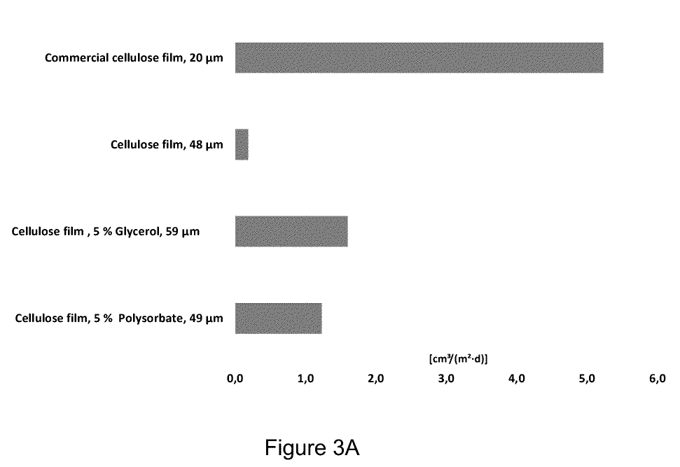

Oxygen transmission rate of the cellulosic film at 23° C. 50% relative humidity is shown in FIG. 3A and grease permeability at 40° C. in FIG. 3B.

### Example 2

The coating of the fiber composition (fiber body, i.e. a base layer) with a cellulosic filmic layer was assessed. The cellulosic filmic layer was applied directly by sandwiching the structures in a compression molding process. Initially the fiber body and filmic layer were conditioned at appropriate humidity chamber and compression molding was done at 80° C. with 410 kp pressure for 20 mins or 95° with 650 kp pressure for 20 min. The pre-conditioning of the fiber body and the film and application pressure and temperature can be adjusted depending on the needs.

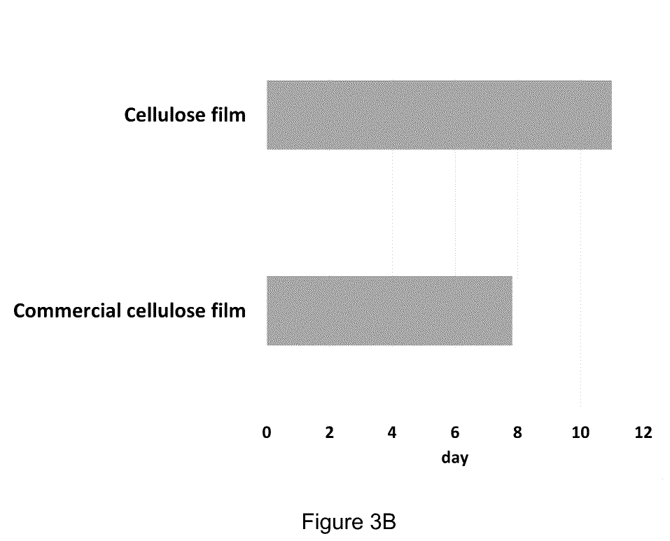

Packaging material produced by compression molding a fiber body with a cellulosic filmic layer is shown in FIG. 4.

### Example 3

The coating of a fiber composition (fiber body, i.e. a base layer) with cellulosic film, applied by calendering process, was assessed. Initially the fiber body and/or film was/were conditioned at appropriate humidity chamber and calendaring was done at 80° C. with 500 kp pressure or 100° C. with 6000 kp pressure. The pre-conditioning of the fiber body and the film and application pressure and temperature can be adjusted depending on the needs.

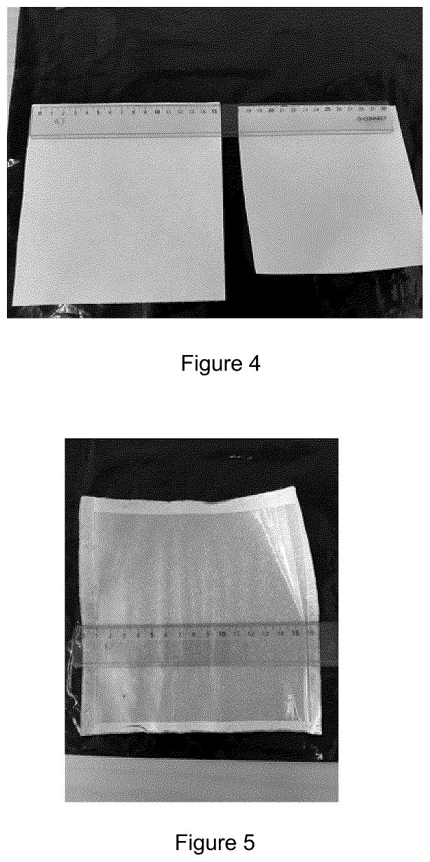

FIG. 5 illustrates packaging material produced by calendering a fiber body with cellulosic film.

### Example 4

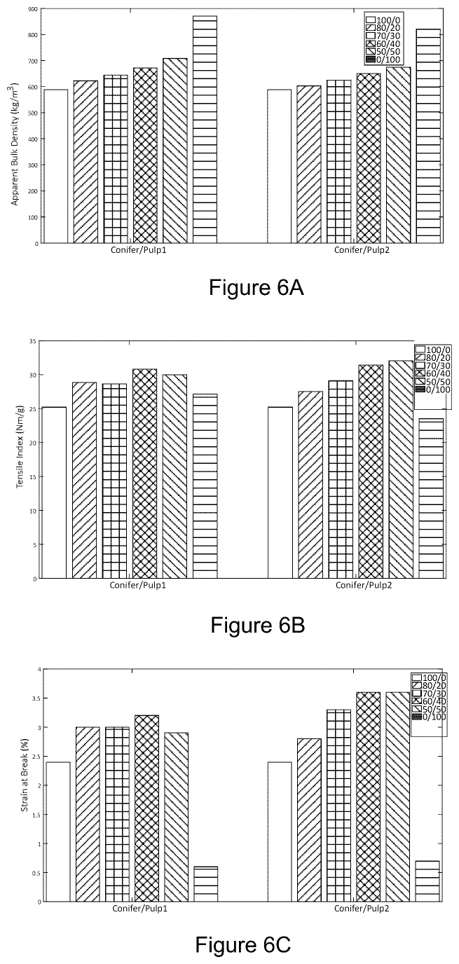

The physical and mechanical properties of a mixture comprising kraft conifer pulp fibers with hydrolyzed kraft conifer pulp fibers with different CED viscosities were assessed. Pulp1 refers to hydrolyzed kraft conifer pulp fiber with CED viscosity of 166 ml/g and Pulp2 refers to hydrolyzed kraft conifer fiber with CE D viscosity of 200 ml/g. Formulation x:y represents the dry weight fiber mixture with kraft conifer pulp fibers: Pulp1 or Pulp2. For example, 60:40 represents to the formulation having 60% of kraft conifer pulp fibers with 40% of Pulp1 or Pulp2. The physical-mechanical properties of the formulations are shown in FIGS. 6A, 6B and 6C, respectively.

FIG. 6A illustrates apparent bulk density values for specific fiber mixtures.

FIG. 6B shows tensile index values for specific fiber mixtures.

FIG. 6C shows strain at break values for specific fiber mixtures.

### Example 5

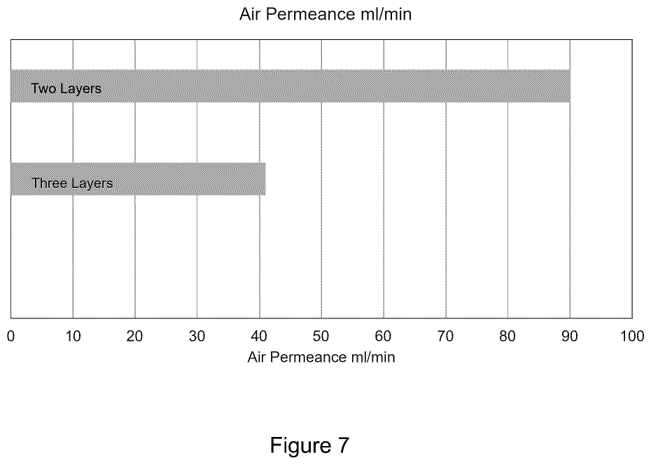

Multilayered sheets were produced as a combination of two or three layers by combining base conifer layer with Pulp 1 (hydrolyzed kraft conifer pulp fiber with CED viscosity of 166 ml/g) in different combinations. For instance, two layered sheets were produced by layering conifer base layer with Pulp 1 layer. For three layers the Pulp 1 layer was sandwiched between two conifer layers. The air permeances of resulting multilayered structures were measured based on ISO 5636-3 and are shown in FIG. 7.

It is obvious to a person skilled in the art that with the advancement of technology, the basic idea may be implemented in various ways. The embodiments are thus not limited to the examples described above; instead they may vary within the scope of the claims.

The embodiments described hereinbefore may be used in any combination with each other. Several of the embodiments may be combined together to form a further embodiment. A process, a product, or a use disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature(s) or act(s) followed thereafter, without excluding the presence of one or more additional features or acts.

1. A product comprising a layer formed at least partially of a mixture comprising a reinforcing component and at least 10% (w/w) of cellulose fibers having surface-closing properties.

2. The product according to claim 1, wherein the product is mainly formed of cellulose-based materials, and/or wherein the reinforcing component comprises or is cellulose fibers.

3. The product according to claim 1, wherein the product is a packaging material, a packaging paper, a wrapping paper, a protective paper, a packaging board, a packaging 3D material, a decorative paper, an envelope, a container, or a release liner.

4. The product according to claim 1, wherein the product is a moldable product or a molded product.

5. The product according to claim 1, wherein the product is biodegradable as deter-mined by the standard OECD for testing of chemicals 301 F.

6. The product according to claim 1, wherein the cellulose fibers having surface-closing properties comprise or are modified cellulose fibers.

7. The product according to claim 1, wherein the cellulose fibers having surface-closing properties have a CED viscosity in the range of 50 to 500 ml/g.

8. The product according to claim 1, wherein the reinforcing component comprises or is chemical pulp, and/or staple fibers.

9. The product according to claim 1, wherein the product further comprises a surface chemical for providing barrier properties applied to the layer.

10. The product according to claim 1, wherein the layer is densified and/or compressed.

11. The product according to claim 1, wherein the layer has a weight in the range of 20 to 1000 gsm.

12. The product according to claim 1, wherein the product does not comprise any plastic or metal.

13. The product according to claim 1, wherein the product further comprises a cellulosic filmic layer.

14. The product according to claim 1, wherein the product has an oxygen transmission rate of 1000 cm³/(m²·day) or less.

15. The product according to claim 1, wherein the product is semi-transparent and/or translucent.

16. A method for producing a product comprising a layer the method comprising:
forming the layer from a mixture comprising a reinforcing component and at least 10% (w/w) of cellulose fibers having surface-closing properties.

17. The method according to claim 16, wherein the forming includes forming the mixture comprising the reinforcing component, and the cellulose fibers having surface-closing properties into a web and calendering the web.

18. The method according to claim 16, wherein the method further comprises molding the product.

19. The method of claim 18, wherein the product is molded from a dry web or from a suspension.

20. The product according to claim 9, wherein the surface chemical is starch, a wax, a fatty acid, an alkyl ketene dimer, an alkyl succinic anhydride, a thermoplastic component, or any combination or mixture thereof.
